(19) United States
(12) Patent Application Publication
(10) Pub. No.: US 2006/0210843 A1
(43) Pub. Date: Sep. 21, 2006

(54) Multiplexer and system for supplying current to an electrochemical cell stack

(76) Inventors: Stephane Masse, Toronto (CA); Rami Michel Abouatallah, Toronto (CA)

Correspondence Address: BERESKIN AND PARR, 40 KING STREET WEST, BOX 401, TORONTO, ON, M5H 3Y2, CA

(21) Appl. No.: 11/118,470

(22) Filed: May 2, 2005

Related U.S. Application Data
(63) Continuation-in-part of application No. 11/081,521, filed on Mar. 17, 2005.

(51) Int. Cl. H01M 8/04

(52) U.S. Cl. 429/13; 429/22

(57) ABSTRACT

Embodiments of the present invention relate to multiplexing apparatus, systems and methods for use in diagnostic testing of an electrochemical cell stack, such as a fuel cell stack or an electrolyzer cell stack. According to one embodiment, the apparatus comprises a multiplexer for switching current to one or more cells in the electrochemical cell stack and a power supply module for supplying power to the multiplexer. The apparatus further comprises a control module electrically connected to and configured to control the multiplexer and the power supply module to supply current to individual cells or groups of cells during automatic diagnostic testing of the electrochemical cell stack. The multiplexer comprises a microprocessor and a plurality of switching circuits adapted to supply current or voltage from the power supply module to the cells.

### RELATED APPLICATIONS

This application is a continuation-in-part of U.S. patent application Ser. No. 11/081,521, filed on Mar. 17, 2005 and entitled “Method, System and Apparatus For Diagnostic Testing Of An Electrochemical Cell Stack”, the entire contents of which is hereby incorporated by reference.

### FIELD OF THE INVENTION

The present invention relates to a multiplexer for supplying current to an electrochemical cell stack and to corresponding systems and methods employing the multiplexer.

### BACKGROUND OF THE INVENTION

Fuel cells and electrolyzer cells are usually collectively referred to as electrochemical cells. Fuel cell-based systems are seen as an increasingly promising alternative to traditional power generation technologies, at least in part due to their low emissions, high efficiency and ease of operation. Generally, fuel cells operate to convert chemical energy into electrical energy. One form of fuel cell employs a proton exchange membrane (PEM), where the fuel cell comprises an anode, a cathode and a selective electrolytic membrane disposed between these two electrodes.

In a catalyzed reaction, a fuel such as hydrogen is oxidized at the anode to form cations (protons) and electrons. The proton exchange membrane facilitates the migration of protons from the anode to the cathode. The electrons cannot pass through the membrane and are forced to flow through an external circuit, thus providing an electrical current. At the cathode, oxygen reacts at the catalyst layer with electrons returned from the electrical circuit to form anions. The anions formed at the cathode react with the protons that have crossed the PEM to form liquid water as the reaction product, known as product water.

An electrolyzer cell uses electricity to electrolyze water to generate oxygen from its anode and hydrogen from its cathode. Similar to a fuel cell, a typical solid polymer water electrolyzer (SPWE) or proton exchange membrane (PEM) electrolyzer is also comprised of an anode, a cathode and a proton exchange membrane disposed between the two electrodes. Water is introduced to, for example, the anode of the electrolyzer which is connected to the positive pole of a suitable direct current voltage. Oxygen is produced at the anode by the reaction: H₂O=1/2O₂+2H⁺+2e⁻.

The protons then migrate from the anode to the cathode through the membrane. On the cathode which is connected to the negative pole of the direct current voltage, the protons conducted through the membrane are reduced to hydrogen following the reaction: 2H⁺+2e⁻=H₂.

Fuel cell systems normally employ a series of fuel cells together in what is called a fuel cell stack. Prior to installing a fuel cell stack in a fuel cell-based power generation system, it is desirable to test the stack to ensure that it functions properly and will operate within the appropriate operating parameters. It may also be desirable to perform such testing as a part of a diagnostic process once the stack has been in used for some time, for example where the stack performance appears to be sub-standard.

Other electrochemical cells, such as electrolyzer cells, may be similarly arranged in series to form an electrolyzer cell stack. Testing of such electrolyzer cell stacks is also desirable, for example for diagnostic or quality assurance purposes.

Testing systems for electrochemical cells have been developed. One such testing system is the fuel cell automatic test station (FCATS), developed by Hydrogenics Corporation. The FCATS is a sophisticated testing system which allows a fuel cell or fuel cell stack to be tested in isolation. The FCATS provides a range of tests and provides full reactant feeds, ensures an appropriate operating environment (e.g. appropriate humidity levels of the air supply to the cathode) and monitors various process parameters and conditions as the fuel cell or fuel cell stack is running. The FCATS is not, however, designed for automatic diagnostic testing of electrochemical cell stacks that are not operating to consume reactants.

Common problems in electrochemical cell stacks include short-circuiting between the anode and cathode of individual cells within the stack, leakage of gases between the anode, cathode or coolant chambers of the cells, as well as electrochemical cross-over of reactants anode to cathode or vice versa. Current manual methods for conducting each of these tests are cumbersome and are prone to human error. Further, each of the tests for these problems is conducted separately on separate makeshift or dedicated apparatus.

Further, where it is desired to provide current to one or more cells in an electrochemical stack, it would be desirable to provide some means by which current may be readily switched between a current source and the various electrochemical cells to which current is to be supplied. However, most available switching-element integrated circuits are designed for telecommunications applications and are not suited to supplying the higher current required for electrochemical cells because of their prepackaged low-current switching transistors. On the other hand, relays may be used for switching currents to the electrochemical cells as they can handle higher current levels. However, relays take up a relatively large amount of space on a printed circuit board and introduce additional mechanical complexities and reliability issues.

It is an object of the present invention to address or ameliorate one or more shortcomings or disadvantages associated with existing systems, apparatus or methods for supplying current or voltage to electrochemical cell stacks, or to at least provide a useful alternative thereto.

### SUMMARY OF THE INVENTION

Aspects of the invention are generally directed to multiplexing apparatus, systems and methods for supplying current or voltage to cells during automated diagnostic testing of electrochemical cell stacks.

One aspect of the invention relates to a multiplexer for supplying current to one or more electrochemical cells in an electrochemical cell stack during diagnostic testing of the stack. The multiplexer comprises a microcontroller, a power supply circuit and a plurality of switching circuits. The power supply circuit is responsive to power control signals from the microcontroller to supply power to the plurality of switching circuits. Each switching circuit switchably supplies current to respective electrochemical cells during the diagnostic testing, in response to the switching control signals from the microcontroller.

In one embodiment of the multiplexer, the power supply circuit comprises a first power switch for supplying power to the switching circuits when the first power switch is closed, the first power switch being operable to open or close in response to a first power control signal from the microcontroller. Further, the power supply circuit preferably comprises a second power (discharge) switch for discharging voltage from the electrochemical cells when the first power switch is open and the second power switch is closed. The second power switch is operable to open or close in response to a second power (discharge) control signal from the microcontroller. The power supply circuit further comprises a discharge resistor connected in series with the second power switch to discharge residual voltage from the electrochemical cells.

Preferably, each of the switching circuits is configured to receive a varying input voltage from the power supply circuit and to output a correspondingly varying output current to a respective electrochemical cell.

Preferably, the microcontroller is configured to output a first switching signal or a second switching signal to each switching circuit. When the microcontroller outputs the first switching signal to one of the switching circuits, that switching circuit is enabled to source current to the respective electrochemical cell. Depending on the input voltage of the switching circuit, the first switching signal enables first and second transistors or a third transistor to conduct current. When the input voltage is large, the first and second transistors operate to pass current to the corresponding electrochemical cell via the second transistor. When the input voltage is small, the third transistor operates to pass current to the corresponding electrochemical cell. The second switching signal enables a fourth transistor to sink current from the corresponding electrochemical cell.

In another aspect, the invention relates to apparatus for diagnostic testing of an electrochemical stack cell. The apparatus comprises the multiplexer described above and further comprises a power supply module and a control module. The power supply module supplies power to the power supply circuit of the multiplexer, while the control module automatically controls the power supply module to vary the power supplied to the power supply circuit and automatically controls the microcontroller of the multiplexer to transmit the power control signals and the switching control signals. The apparatus may further comprise a voltage monitor electrically connected to the electrochemical cell stack to measure the voltages between electrodes of a selected electrochemical cell within the stacks.

In a further aspect, the invention relates to a method for supplying current to one or more electrochemical cells in an electrochemical cell stack during diagnostic testing of the stack. The method comprises providing a multiplexer as described above, transmitting a power control signal from the microcontroller of the multiplexer to the power supply circuit to cause the power supply circuit to supply power to the plurality of switching circuits and transmitting switching control signals from the microcontroller to selected ones of the switching circuits to cause the selected switching circuits to supply current to respective electrochemical cells.

A further aspect of the invention relates to a multiplexing system for supplying current to one or more electrochemical cells in an electrochemical cell stack. The system comprises a multiplexer as described above, a power supply module and a control module. The power supply module supplies power to the power supply circuit of the multiplexer and the control module is programmed to control the power supply module to vary power supplied to the power supply circuit and to control the microcontroller to transmit the power control signals and the switching control signals.

Preferably, the switching circuits each comprise transistors for switching current to the electrochemical cells. The transistors have a relatively high current tolerance and are therefore suitable for switching current to electrochemical cells. Preferred transistors for such an application include MOSFETs.

The control module preferably comprises a computer processor having computer program instructions stored in an associated memory or otherwise accessible to the computer processor. The computer program instructions, when executed by the computer processor, cause the control module to automatically conduct the diagnostic testing. Advantageously, the computer program instructions allow for automated operation of the multiplexer alone or in combination with other modules in a diagnostic testing system.

Advantageously, the multiplexer according to one embodiment of the invention is designed to switch current to the electrochemical cells within the stack. This is done using a series of current switching circuits within the multiplexer, each current switching circuit corresponding to a particular cell in the stack. These current switching circuits are transistor-based circuits which receive a DC voltage and, depending on signals from the multiplexer microcontroller, apply the voltage to the corresponding cell.

Advantageously, the current switching circuits avoid the need for switching using relays, with their inherent mechanical limitations on reliability and bulky, low-density packing, while providing comparable current switching capability. Existing switching element integrated circuits are relatively high-density but cannot handle the current levels required to be supplied to a fuel cell stack. Thus, the current switching circuits employed in the multiplexer advantageously provide relatively high density on a printed circuit board and, at the same time, allow currents of a higher magnitude to be switched to the various cells in the stacks.

Advantageously, certain embodiments of the invention may be employed as part of a diagnostic testing system for an electrochemical cell stack. The control module of the testing system executes program instructions for controlling a gas supply module to provide gas to the electrochemical cell stack, either as part of leak testing or short-circuit testing or hydrogen crossover testing. As part of the gas leak testing, short-circuit testing and hydrogen crossover testing, the multiplexer acts as a current or voltage supply to one or more of the cells in the electrochemical cell stack. A voltage monitor of the diagnostic testing system measures the potential difference across the anode and cathode plates of selected one or more cells of the electrochemical cell stack in order to determine the electrical characteristics of those cells under the test conditions.

### BRIEF DESCRIPTION OF THE DRAWINGS

Embodiments of the invention are hereinafter described in further detail, by way of example only, with reference to the accompanying drawings, in which:

FIG. 1 is a block diagram of a diagnostic testing system according to an embodiment of the invention;

FIG. 2 is a block diagram of an example control module of the diagnostic testing system of FIG. 1;

FIG. 3 is a block diagram showing an example multiplexer of the diagnostic testing system of FIG. 1;

FIG. 4 is a circuit diagram of a switching circuit of the multiplexer,

FIG. 5 is a block diagram showing an example voltage monitor of the diagnostic testing system of FIG. 1; and

FIG. 6 is a process flow diagram of a method of supplying current according to an embodiment of the invention.

### DETAILED DESCRIPTION OF THE INVENTION

Preferred embodiments of the invention will now be described in further detail, with reference to the drawings. Like reference numerals in the drawings indicate like features or functions as between the indicated elements in the drawings.

Embodiments of the invention generally relate to methods, systems and apparatus for use in automatic diagnostic testing of electrochemical cell stacks. The diagnostic testing may involve testing for gas leaks between the anode, cathode and coolant chambers, testing for short-circuits between the anode and cathode of each cell in the stack and testing for cross-over of electrochemical reactants between the anode and cathode or vice versa.

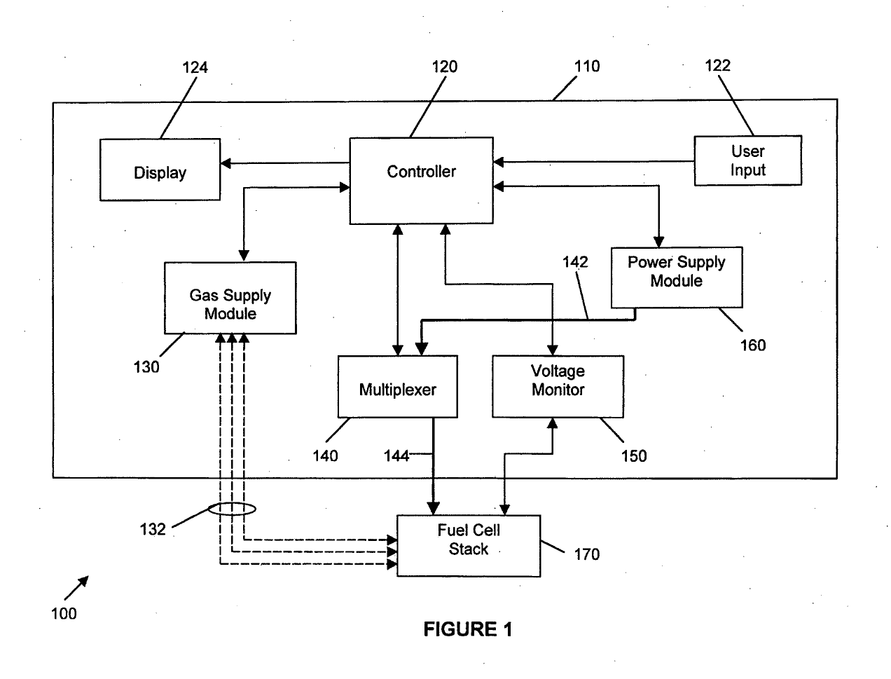

Referring now to FIG. 1, there is shown a diagnostic testing system 100. Diagnostic testing system 100 comprises a control module 120, a display 124, user input means 122, a gas supply module 130, a multiplexer 140, a voltage monitor 150 and a power supply module 160. Control module 120 provides a display output to the display 124 for displaying test data and diagnostic reports to an operator supervising the diagnostic testing. Control module also receives user input signals from the operator via the user input means 122. Such user input means includes at least a keyboard or keypad and may include a mouse and/or a touch-sensitive screen.

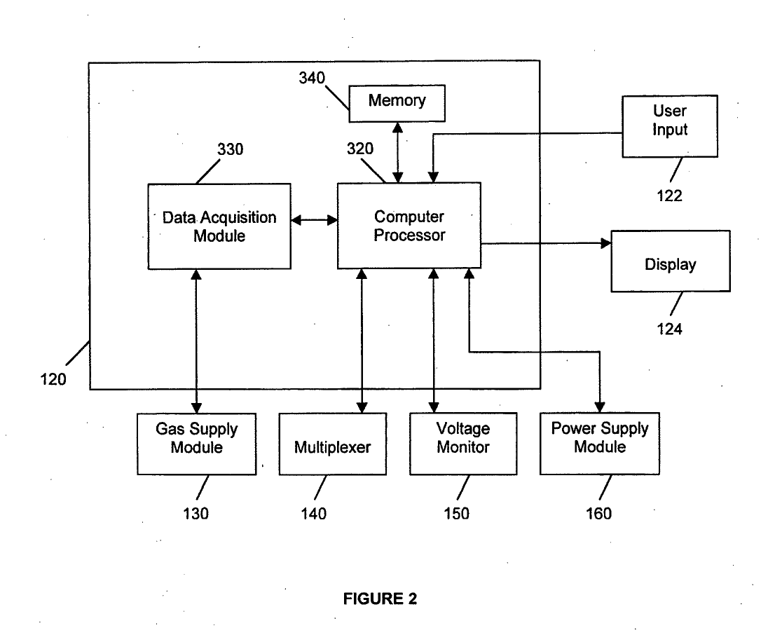

Control module 120 is electrically connected to gas supply module 130, multiplexer 140, voltage monitor 150 and power supply module 160 for communication therewith and control thereof. Control module 120 is shown and described in further detail in relation to FIG. 2.

Diagnostic testing system 100 further comprises a housing 110. Housing 110 is preferably in the form of a cabinet or cart of a relatively mobile form. The control module 120, gas supply module 130, multiplexer 140, voltage monitor 150, power supply module 160, display 124 and user input 122 are preferably all housed within housing 110. Housing 110 further comprises gas supply lines 132 running from gas supply module 130 and connectible to a fuel cell stack 170 for supplying gas thereto during the diagnostic testing.

A fixed voltage power supply (not shown) supplies power to each of the components or modules housed in housing 110, including the control module 120, for performing their respective functions. In order to do this, the fixed-voltage power supply receives mains power (not shown) and transforms it as necessary to supply DC power to the various components and modules of diagnostic testing system 100, including power supply module 160.

Power supply 160 is dedicated to providing a configurable (variable) voltage to multiplexer 140, according to stack testing needs. Power supply module 160 preferably comprises a voltmeter and a multimeter (or other current measuring device) to measure its output voltage and current, respectively. Alternatively, the voltmeter and multimeter may be provided separately from the power supply module 160. The voltmeter and multimeter provide output signals to control module 120 that correspond with their measured voltage and current values.

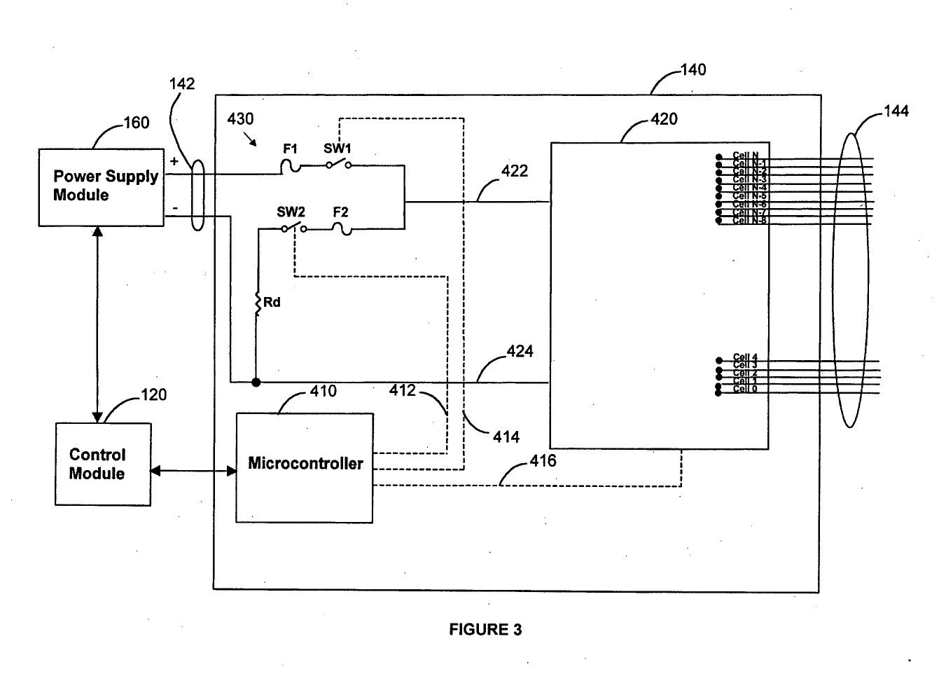

In particular, power supply module 160 supplies power to multiplexer 140 via a multiplexer power supply cable 142 and the multiplexer 140 uses this power to provide current or voltage to various of the cells in the fuel cell stack 170 via stack power supply conductors 144. Multiplexer 140 is shown and described in further detail in relation to FIG. 3.

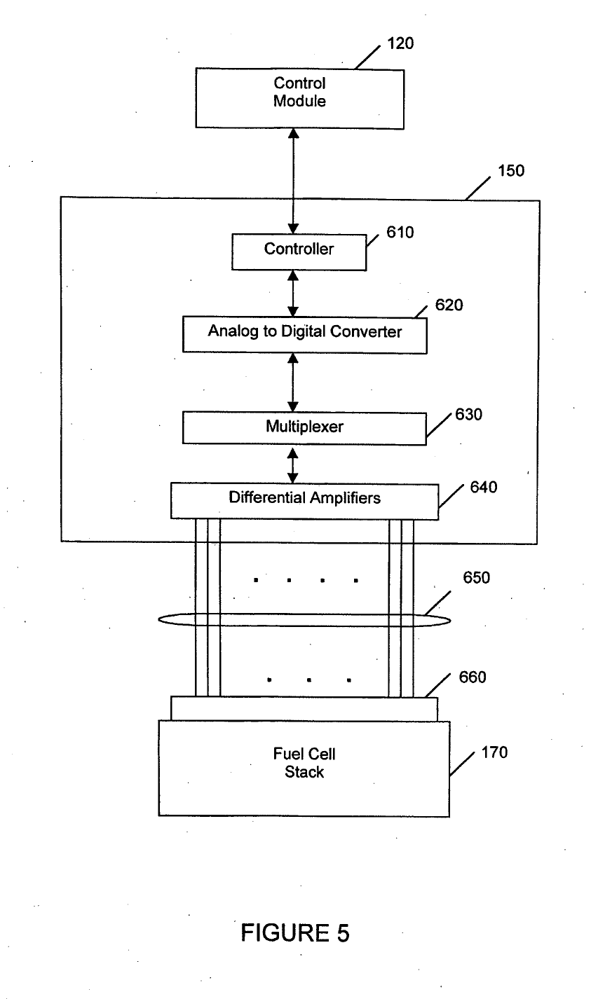

Voltage monitor 150 is used to measure the electrical potential at various of the anode or cathode plates within the cells of the fuel cell stack 170 in order to assist in determining the electrical or electrochemical performance of such cells. Voltage monitor 150 is shown and described in further detail in relation to FIG. 5.

Fuel cell stack 170 comprises at least one cell, but may have in the order of 30, 60 or 100 cells arranged in series. All such cells receive gas at their anode plates through a common anode gas conduit and receive gas at their cathode plates through a common cathode gas supply conduit. Further, coolant is supplied to all of the cells through a common coolant supply conduit. Supply lines 132 are connected to the respective inlets and outlets of these conduits for supplying gas to each of the conduits separately, depending on the particular testing step being carried out.

The various components of fuel cell stack 170 may malfunction in various ways. For example, the proton exchange membrane of a cell may have a hole in it, or the membrane and sealing gasket may incompletely separate the anode and cathode plates from each other. If there is a hole in the membrane, reactant gases may pass from the anode chamber to the cathode chamber through the hole and reduce the current generating characteristics of the cell. If the anode and cathode plates are not completely separated from one another, the cell may be short-circuited, in which case the cell would not generate normal current levels during normal operation.

When one or more cells within an electrochemical cell stack does not operate within expected operating parameters, the performance of the entire stack becomes sub-optimal. Accordingly, for quality control and quality assurance purposes, diagnostic testing of an electrochemical cell stack is desirable, in order to determine, and, if possible, correct, the causes of sub-optimal performance of the stack.

During the diagnostic testing of the stack, as described herein, the stack is not operated or run in simulation. That is, unlike the FCATS, the diagnostic testing system 100 does not simulate actual operating conditions of the stack. Rather, the stack has voltages and/or currents and/or gases supplied to its cells and the resultant gas flows and/or cell voltages are measured. Depending on the particular problem experienced by a cell in the stack, the measured cell characteristics may be different. For this reason, several different tests may be necessary in order to identify the problem experienced by that cell. For example, if a membrane imperfectly separates the cathode and anode plates of a cell because of a faulty seal, this may not be revealed by testing whether there is any gas leakage between the cathode and coolant chambers of that cell. Further, if more than one diagnostic test indicates the existence or likely existence of a particular problem, this serves to increase the reliability of the test data being gathered about the stack.

Once it is determined that a leak exists somewhere within stack 170, control module 120 proceeds to conduct cell-specific leak checking. If the overall leak check does not indicate the existence of any leaks in the stack 170, control module 120 proceeds to perform the other diagnostic tests, as described later.

Referring now to FIG. 2, the control module 120 is described in further detail. Control module 120 comprises a computer processor 320, a data acquisition module 330 and a memory 340 accessible to the computer processor 320.

Computer processor 320 communicates with data acquisition module 330 to transmit control signals to the valves and flow controllers in gas supply module 130 and to receive data back from the flow sensors and pressure transmitters of gas supply module 130. Thus, data acquisition module 330 provides analog to digital and digital to analog conversion to facilitate the communication of signal data between the (digital) computer processor 320 and the (analog) instrumentation of gas supply module 130.

Data acquisition module 330 may regularly sample or interrogate the flow and pressure instrumentation within gas supply module 130, storing such sample data within a dedicated memory (not shown) thereof for access by the computer processor 320 when the information is required. Alternatively, data acquisition module 330 may only temporarily buffer the digitized data from gas supply module 130 before passing it on to computer processor 320.

Computer processor 320 acts as the overall controller for the diagnostic testing system 100, communicating with other parts of the system, including data acquisition module 330, multiplexer 140, voltage monitor 150 and power supply module 160. Further, signals from user input means 122 are transmitted to the computer processor 320 for processing in a known fashion and computer processor 320 transmits display signals to display 124 for displaying graphics or other visual information to personnel operating the diagnostic testing system 100.

Computer processor 320, in its function as the overall controller for the diagnostic testing system 100, executes computer program instructions stored in memory 340. Execution of the computer program instructions causes the computer processor 320 to communicate with the various other modules or components of the diagnostic testing system 100 to automatically carry out the testing procedures, determine the condition of the cells in the stack and generate reports regarding the condition of the cells.

Advantageously, computer processor 320 may execute computer program scripts in a language for automated fuel cell testing. Such a language for facilitating automated fuel cell testing is described in U.S. patent application Ser. No. 10/244,609, filed on Sep. 17, 2002, the entire contents of which is hereby incorporated by reference. Advantageously, use of a predetermined script in such a language (when executed by computer processor 320) allows the automated, unattended operation of diagnostic testing system 100, including automated operation of multiplexer 140 under the control of computer processor 320.

Computer processor 320 may also be in communication with one or more peripheral devices, such as a printer, or may be in communication with a network via a suitable network connection (not shown). Advantageously, computer processor 320 may be in communication with a network via the network connection in order to provide diagnostic test reports to remote systems over the network or to receive controller instructions from a remote source.

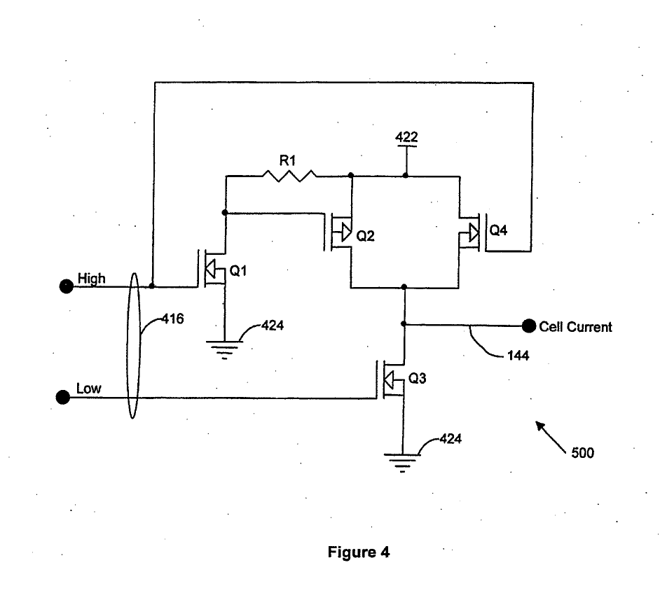

Referring now to FIG. 3, the multiplexer 140 is described in further detail. Multiplexer 140 comprises a microcontroller 410, a switching circuit block 420 comprising a plurality of current switching circuits 500 (shown in FIG. 4) and a power switching circuit 430. Microcontroller 410 is configured to provide switching control signals on switching control lines 416 to each of the switching circuits 500 in switching circuit block 420 for selectively providing current to, or sinking current from, any of cells 0 to N in the stack via stack supply conductors 144. N may be the number of any standard number of cells in a fuel cell stack or electrolyzer cell stack. Switching circuit block 420 receives a supply voltage from power supply module 160 via power supply circuit 430. For this purpose, mulitplexer power supply cable 142 is electrically connected between the power supply module 160 and the power supply circuit 430 of multiplexer 140.

Power supply circuit 430 comprises a power supply enable switch (first switch) SW1, which, when closed, completes a circuit between power supply module 160 and switching circuit block 420 via an active conductor 422 and a neutral conductor 424. A first fuse F1 is connected in series with switch SW1 to guard against excessive current flow through active conductor 422 when switch SW1 is closed. When switch SW1 is open, active conductor 422 is not connected to power supply module 160. Switch SW1 is opened or closed, depending on a power supply switching signal on power switching line 414 from microcontroller 410.

Power supply circuit 430 further comprises a second switch SW2, which, when closed (and SW1 is open) completes a discharge circuit with switching circuit block 420 via active conductor 422 and neutral conductor 424 through discharge resistor Rd (of about 150 Ohms). Switch SW2 is opened or closed in response to a discharge control signal on discharge control line 412 from microcontroller 410. Microcontroller 410 controls switches SW1 and SW2 so that they are not both closed at the same time. A second fuse F2 is connected in series with switch SW2 in order to prevent excessive current flow through the discharge circuit.

Microcontroller 410 transmits control signals on lines 412, 414 and 416 in response to corresponding instructions transmitted from control module 120 during operation of the diagnostic testing system 100. Thus, microcontroller 410 can be controlled in an automated fashion by control module 120 to supply signals on lines 412, 414 and 416 in a predetermined manner to supply current to the cells during testing. For example, when, as part of the short-circuit testing, a voltage is to be applied across the cells of the stack, control module 120 issues an appropriate command, for example via an RS-232 connection, to microcontroller 410, which closes switch SW1, opens switch SW2 (if not already open) and provides switching control signals on lines 416 to the switching circuits in switching circuit block 420 to provide a voltage across the cells of the stack via a stack power supply conductors 144. Individual cell voltages are then measured by the voltage monitor 150, as described later.

Power supplied to power supply circuit 430 from power supply module 160 via multiplexer power supply cable 142 is controlled by computer processor 320 to supply voltages or currents of greater or lesser magnitudes, depending on the testing requirements. For this purpose, the computer processor 320 of control module 120 communicates, preferably via a general purpose interface bus (GPIB), with power supply module 160 to set the output current and/or voltage level of power supply circuit 430. Advantageously, switching circuits 500 are configured to provide small voltages to the cells, as well as higher voltages in response to corresponding current or voltage levels at power supply circuit 430.

Typically, when using logic controlled MOSFETs, the turn on threshold voltage level would be around 2.7 volts. In multiplexer 140, it is desirable to have current switching circuitry that can operate above the turn on voltage of 2.7 volts (when a group of cells is being tested) and can alternatively operate below the turn on voltage of 2.7 volts (when only one or two cells are being tested). This can be done using the switching circuits 500 as described below.

Advantageously, multiplexer 140 can selectively provide current or voltage to any cell within the stack by selectively switching on the corresponding switching circuit 500 for that cell. Similarly, current or voltage may be supplied to one or more selected groups of cells, thus allowing the diagnostic testing to focus on specific cells or groups of cells. Further, switching circuit block 420 may have a large number of switching circuits 500, for example, more than a hundred, allowing large stacks to be tested and allowing high currents, for example, up to about 8 amps, to be passed through the switching circuits 500.

Once testing of a cell or group of cells is completed, control module 120 issues an appropriate command to microcontroller 410 via the GPIB. The microcontroller 410 in turn transmits an “OPEN” power supply switching signal 414 to open switch SW1 and transmits an appropriate “CLOSE” discharge control signal 412 to close switch SW2, thereby completing the discharge circuit and allowing voltage remaining in the tested cells to be discharged through resistor Rd.

Referring now to FIG. 4, one of the plurality of switching circuits 500 is shown and described in further detail. Switching control signals 416 may be received at each of switching circuits 500 at either a “high” signal line or a “low” signal line of the switching circuit 500. Supply voltage is received by each switching circuit 500 from active conductor 422 when switch SW1 is closed. Each switching circuit 500 is effectively “grounded” by a connection to neutral conductor 424, which is connected to the negative terminal of the power supply of power supply module 160. Each switching circuit 500 has an output conductor corresponding to one of the stack power supply conductors 144.

The high and low signal lines of each switching circuit 500 effectively select the operating mode for that circuit. If the high signal line is active, the switching circuit 500 acts as a current source. However, if the low signal line is active, the switching circuit 500 acts as a current sink. The high and low signal lines cannot be both active at the same time. However, if neither of the high or low signal lines is active, the switching circuit 500 is effectively inoperative or “switched off”.

The low signal line is connected to the gate of a transistor Q3, such that, when the low signal line is active, transistor Q3, which is an N-channel MOSFET (metal-oxide semiconductor field-effect transistor), is enabled, effectively drawing current from the corresponding cell to ground (although this is actually to neutral conductor 424).

For switching circuit 500 to operate as a current source, the high signal line must be active. If the input voltage on voltage supply conductor 422 is relatively large, for example in the order of 50 volts, transistor Q1, which is an N-channel MOSFET, and transistor Q2, which is a P-channel MOSFET, which are together formed as a load switch, will operate to draw current through transistor Q2 to stack supply conductor 144. As the low signal line is inactive, transistor Q3 is disabled and does not sink the current drawn-though transistor Q2.

The load switch configuration formed by transistors Q1 and Q2 also comprises a resistor R1 connected between the high potential side of transistor Q2 and the high potential side of transistor Q1. The gate of transistor Q2 is connected to the high potential side (drain) of transistor Q1. Resistor R1 is a biasing resistor that pulls up the gate of transistor Q2 to the level of the supply voltage 422. This effectively maintains transistor Q2 in a disabled state, unless transistor Q1 pulls the gate of transistor Q2 to ground.

If the voltage of supply voltage 422 is large enough (for example, above the turn on threshold voltage of about 2.7 volts) to polarize transistor Q2, it will let current flow, as long as transistor Q1 is enabled by the high signal line. However, if supply voltage 422 is relatively small (for example, below the turn on threshold voltage of about 2.7 volts), then transistor Q4, which is an N-channel MOSFET, will be enabled by the high signal line instead and will supply current to stack supply conductor 144.

With the described configuration, switching circuit 500 can source current from a range of supply voltages on active supply conductor 422, limited only by the breakdown voltages of the various transistors. Being able to source current from a range of voltages on active supply conductor 422 is important as various voltage or current levels will be required to be supplied to stack supply conductors 144 during the diagnostic testing. For example, for a single cell test, the voltage can be as low as 0.3 volts, whereas for a group of cells or even for an entire stack, the voltage requirement may exceed 50 volts.

It will be understood that switching circuit 500 can be implemented in forms other than those shown in FIG. 4 and described in relation thereto. For example, the polarity of the circuit may be reversed, if desired, and P-channel MOSFETs can be used in place of N-channel MOSFETs and vice-versa, providing that the switching circuit 500 thus modified can switchably supply or sink current and/or voltage to the cells of an electrochemical cell stack. Further, any modified versions of switching circuit 500 should still allow current to be supplied to the cell from a range of supply voltages on the supply conductor.

Referring now to FIG. 5, voltage monitor 150 is described in further detail. Voltage monitor 150 is electrically connected between control module 120 and fuel cell stack 170. Between control module 120 and voltage monitor 150, the electrical connection is provided by a communication cable or other communication connection. Voltage monitor 150 is connected to fuel cell stack 170 by a plurality of voltage sensing conductors 650. Voltage sensing conductors 650 are connected to fuel cell stack 170 so as to measure the electrical potential between the anode and cathode plates of each cell.

A voltage monitor analogous to voltage monitor 150 is described in commonly owned co-pending U.S. patent application Ser. No. 09/865,562, filed May 29, 2001, the entire disclosure of which is hereby incorporated by reference. U.S. patent application Ser. No. 09/865,562 is published under US Publication No. 2002-0180447-A1. Another voltage monitor analogous to voltage monitor 150 is described in commonly owned co-pending U.S. patent application Ser. No. 10/845,191, filed May 13, 2004, the entire disclosure of which is hereby incorporated by reference. Other forms of voltage monitor 150 may be employed, providing that they have the described features and perform the described functions.

As shown in FIG. 5, voltage-sensing conductors 650 connect to the fuel cell stack 170 at a voltage measuring assembly 660. Voltage measuring assembly 660 is described in commonly owned co-pending U.S. patent application Ser. No. 10/778,322, filed Feb. 17, 2004, the entire disclosure of which is hereby incorporated by reference.

The voltage measuring assembly 660 extends parallel to the longitudinal direction of the fuel cell stack 170 and is mounted, at two ends thereof, on the side faces of two end plates of the fuel cell stack 170. The voltage measuring assembly 660 generally comprises a printed circuit board (PCB) (not shown) and a plurality of probes (not shown) detachably secured, for example, by soldering, in a plurality of pinholes (not shown) in the PCB.

The pinholes are formed in a plurality of groups. For example, each pinhole group may consist of three pinholes. The pinholes in each group are electrically connected with one another but each group of pinholes is not in electrical connection with any other group of pinholes. Each group of pinholes is electrically connected to a multi-pin connector (not shown) secured, for example, by soldering, on the PCB via printed circuits (not shown).

One or more such multi-pin connectors may be provided on the PCB and are used to provide an electrical connection with external circuits for analyzing fuel cell voltages measured by the voltage measuring assembly 660. Thus, voltage sensing conductors 650 are coupled to the multi-pin connectors of voltage measuring assembly 660, for example using one or more corresponding wiring harness connectors.

Voltage monitor 150 comprises a controller 610, an analog to digital converter 620, a multiplexer 630 and a series of differential amplifiers 640. Differential amplifiers 640 are connected to voltage sensing conductors 650. Each of the differential amplifiers reads the voltages at two terminals (usually the anode and cathode) of each fuel cell. The differential amplifiers 640 provide an output indicative of the potential difference between the two terminals and this output is provided to the analog to digital converter 620 via multiplexer 630.

Thus, the analog to digital converter 620 reads the output of the differential amplifiers 640 via the multiplexer 630, which provides access to one of the differential amplifiers 640 at any given time. The analog to digital converter 620 may thus poll differential amplifiers 640 in a rapid sequence using multiplexer 630 to sequentially select each of the differential amplifiers 640.

The digital output of the analog to digital converter 620 (in the form of quantized voltage measurements) is provided to controller 610 for processing. The controller 610 controls the operation of the analog to digital converter 620 and the multiplexer 630, processes the digital output it receives and executes software instructions for communicating the received voltage measurements to control module 120. Controller 610 requires relatively little processing capability as much of the processing of the voltage measurement information is performed by computer processor 320 within control module 120. However, controller 610 preferably includes a memory (not shown) for storing any program code necessary for performing its voltage information gathering function.

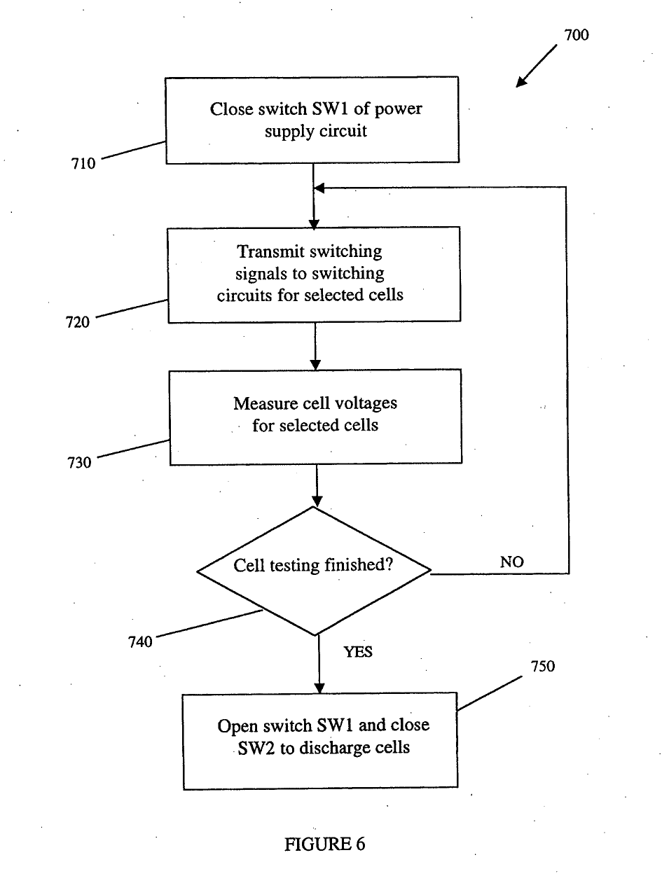

Referring now to FIG. 6, a method 700 of supplying current to the stack is described in further detail. Current supply method 700 uses multiplexer 140 to supply current to fuel cell stack 170 as part of an overall diagnostic testing system and method. Accordingly, method 700 will be described with reference to the steps shown in FIG. 6 and the components of diagnostic testing system 100 shown in FIGS. 1 to 5.

Once computer processor 320 determines that it is time to supply current to fuel cell stack 170, computer processor 320 issues a current supply command to microcontroller 410 of multiplexer 140. This current supply command specifies the cells to which multiplexer 140 is to supply current via current supply conductor 144. The current supply command causes microcontroller 410 to close switch SW1 and open switch SW2, thereby allowing power to be supplied through power supply circuit 430 to switching circuits 500 within switching circuit block 420. The closing of switch SW1 and opening of switch SW2 corresponds to step 710 of method 700.

Once power supply circuit 430 is operable to supply power to the switching circuits 500, microcontroller 410 transmits switching signals on switching control lines 416 to switching circuits 500 for selected cells (specified in the current supply command), at step 720.

As part of the diagnostic testing, the control module 120 may issue control commands to power supply module 160 to increase the DC supply voltage to power supply circuit 430 of multiplexer 140, or otherwise vary the input voltage to switching circuits 500. At step 730, the cell voltage of each cell under test is measured by voltage monitor 150. The voltage monitor 150 may continuously monitor the voltage of each cell (measured as a potential difference between the electrodes of the cell) before, during and after current is supplied to those cells. The voltage monitor 150 uses multiplexer 630 to sequentially select each cell for which the voltage is designed to be measured. The sequential selection is performed in rapid succession, thereby obtaining a set of discrete voltage measurements over time for each cell.

At step 740, the control module 120 checks whether the cell testing is finished. If the current supply is no longer required during the diagnostic test sequence, for example because the cell testing is finished, switch SW1 is opened and switch SW2 is closed, at step 750, to discharge any residual voltage remaining in the cells to which current was supplied. If the cell testing is not finished, steps 720 and 730 are repeated. If step 720 is repeated, it may be in response to a further current supply command from computer processor 320 to microcontroller 410, specifying further cells to which current is to be switched. The current supply command may specify any one or more cells or groups of cells as the number of switching circuits 500 within switching circuit block 420 is sufficiently large to match the cells in the stack one-for-one.

Current supply method 700 may be performed as part of a test sequence for determining whether there is any gas leakage between the coolant chamber and the anode or cathode chamber, whether there is electrochemical (hydrogen) to cross over between the anode and cathode chambers and what during short-circuit testing of the stack.

Once gas supply lines 132, power supply conductors 144 and voltage sensing conductors 650 are connected to fuel cell stack 170, the diagnostic testing of the fuel cell stack 170 may commence.

Leak testing of specific cells may be performed as a coolant-to-anode crossover leak test, a coolant-to-cathode crossover leak test or as part of an electrochemical (hydrogen) crossover test between the anode and cathode chambers of the cells. To test the coolant-to-anode crossover, inert gas is supplied from the gas supply module 130 to the coolant conduit inlet of the stack while blocking the coolant outlet. Air is then supplied from gas supply module 130 to the cathode conduit at a rate of about 2 mL/min/cm²/cell with no back pressure, heating or humidification. Similarly, hydrogen is supplied to the anode conduit of fuel cell stack 170 from gas supply module 130, at a rate of about 0.5 mL/min/cm²/cell with no back pressure, heating or humidification. The inert gas pressure at the coolant inlet is increased to about 20 psig.

With the gases being supplied to the stack as described, the voltage monitor 150 is used to measure the cell voltages. Those cells indicating a substantially lower open circuit voltage than the other cells are determined to have a coolant to anode crossover leak. This is because any inert gas leaking from the coolant chamber of a cell to the anode chamber will dilute the hydrogen at the anode and cause the cell voltage to drop.

The coolant-to-anode and coolant-to-cathode crossover tests may be checked by another (secondary) testing method, as follows. For the secondary coolant-to-anode crossover test, the gas supply module 130 provides hydrogen to the coolant conduit at a rate of about 2 mL/min/cm²/cell, while providing inert gas to the anode conduit of the stack at about 0.5 mL/min/cm²/cell and providing air to the cathode conduit of the stack at about 2 mLlmin/cm²/cell. With the normal gas supply of the anode and coolant conduits being swapped, voltage monitor 150 measures the potential differences between the cells. In such conditions, the potential differences should be low in the absence of a leak.

Control module 120 receives the voltage measurements from voltage monitor 150 and determines whether any of the cells has a large or increasing open circuit voltage relative to the other cells, thus indicating that the hydrogen fuel gas is crossing over from the coolant chamber of such cells to the anode chamber.

The secondary coolant-to-cathode leak test is similar to that described above for the secondary coolant-to-anode leak test, except that voltage monitor 150 measures the cell voltages while air is supplied to the coolant conduit, inert gas is supplied to the cathode conduit and hydrogen is supplied to the anode conduit. Thus, if air crosses over from the coolant chamber to the cathode chamber of a cell, the cell will generate a larger or increasing open circuit voltage relative to the other cells.

In order to determine the likelihood of existence of such a coolant-to-anode or coolant-to-cathode leak, control module 120 performs a comparison of the relative values of the cell voltages and, if the difference is large enough (i.e. above a pre-determined threshold) or if the difference in rate of change of cell voltages is large enough, the control module 120 determines that the cell is affected by a leak from its coolant chamber.

Control module 120 is further programmed to determine the electrochemical crossover rate between the anode and cathode chambers of these cells. This is performed in a roughly similar manner to the coolant-to-anode or coolant-to-cathode crossover leak testing. However, for the hydrogen crossover testing, hydrogen is supplied to the anode conduit and nitrogen or another inert gas is supplied to the cathode conduit. Also, for the cells undergoing the electrochemical (hydrogen) crossover test, multiplexer 140 supplies a voltage to those cells.

During the hydrogen crossover testing, control module 120 controls power supply module 160 so as to incrementally increase the voltage supplied to power supply circuit 430 of multiplexer 140, which in turn increases the current through switching circuits 500, while voltage monitor 150 measures the voltages across each of the cells. The cell current through the cells is measured by the multimeter within the power supply module 160. Alternatively, a separate multimeter may be used in-line with the power supply module 160. Such a separate multimeter would communicate with control module 120 via a GPIB (bus).

If the current of a cell varies sharply with the input voltage to that cell, electrical shorting of the cell is indicated. On the other hand, if the current is substantially constant as the input voltage varies, it is determined that no electrical shorting affects the cell. The level of the constant current corresponds to the hydrogen crossover rate and, accordingly, the crossover rate (in slpm) may be determined by multiplying the constant current value by a constant conversion factor.

In another part of the diagnostic testing, short-circuit testing of the cells of fuel cell stack 170 is performed. Short-circuit testing is performed by supplying inert gas or air to the anode and cathode conduits of the stack, while supplying a voltage across the cells to be tested by multiplexer 140. Simultaneously, voltage monitor 150 monitors the open-circuit potential across the anode and cathode plates of each cell. Initially, the voltage applied across these cells by multiplexer 140 is relatively small, but increases incrementally to a normal cell operating voltage level between about 0.5 to 1.0 volts. Those cells measured to have a substantially lower open circuit potential between their anode and cathode plates, relative to the other cells, are determined to be short-circuited, or at least likely to be short-circuited.

Before supplying the inert gas or air to the fuel cell stack 170 for the short-circuit testing, the stack is preferably flushed with a nitrogen (or other inert gas) purge. Similarly, with the other testing procedures, the stack conduits and cells are preferably purged or flushed so that none of the testing procedures are contaminated by gases or reaction byproducts resulting from earlier tests or operations. Additionally, after each test procedure in which multiplexer 140 provides current or voltage to fuel cell stack 170, microcontroller 410 closes switch SW2 and opens switch SW1 and thereby discharges any residual voltage in the cells through discharge resistor Rd.

Following the diagnostic testing procedures, the results of the testing are stored within memory 340 and the stored tested results are used to generate a diagnostic test report for review on display 124 or via a peripheral device such as a printer. The diagnostic test report may include the measured test results and determinations made by control module 120, based on the test results.

While embodiments have been described herein with reference to hydrogen fuel cells, it is understood that the described apparatus, methods and systems are equally applicable to electrolyzer cells and electrolyzer cell stacks.

Various modifications or enhancements may be made to the described embodiments, without departing from the spirit and scope of the invention.

1. A multiplexer for supplying current to one or more electrochemical cells in an electrochemical cell stack during diagnostic testing of the stack, the multiplexer comprising:
a microcontroller;
a power supply circuit responsive to power control signals from the microcontroller; and
a plurality of switching circuits receiving power from the power supply circuit responsive to the power control signals from the microcontroller, each switching circuit switchably supplying current, responsive to switching control signals from the microcontroller, to respective electrochemical cells during the diagnostic testing.

2. The multiplexer of claim 1, wherein the switching circuits each comprise transistors having a high current tolerance.

3. The multiplexer of claim 2, wherein the transistors are MOSFETs.

4. The multiplexer of claim 1, wherein the power supply circuit comprises a first power switch for supplying power to the switching circuits when the first power switch is closed, the first power switch being operable to open or close in response to a first power control signal from the microcontroller.

5. The multiplexer of claim 4, wherein the power supply circuit comprises a second power switch for discharging voltage from the electrochemical cells when the first power switch is open and the second power switch is closed, the second power switch being operable to open or close in response to a second power control signal from the microcontroller and wherein the power supply circuit further comprises a discharge resistor connected in series with the second power switch for discharging voltage from the electrochemical cells.

6. The multiplexer of claim 1, wherein each switching circuit is configured to receive a varying input voltage from the power supply circuit and to output a correspondingly varying output current to a respective electrochemical cell.

7. The multiplexer of claim 1, wherein the microcontroller is configured to output a first switching signal or a second switching signal to each switching circuit, whereby, when the microcontroller outputs the first switching signal to one of the switching circuits, that switching circuit is enabled to supply current to the respective electrochemical cell and, when the microcontroller outputs the second switching signal to one of the switching circuits, that switching circuit is enabled to sink current from the respective electrochemical cell.

8. The multiplexer of claim 7, wherein, depending on the input voltage of the switching circuit, the first switching signal enables first and second transistors or a third transistor and wherein, when the input voltage is large, the first and second transistors operate to pass current to the respective electrochemical cell via the second transistor and, when the input voltage is small, the third transistor operates to pass current to the respective electrochemical cell.

9. The multiplexer of claim 7, wherein the second switching signal enables a fourth transistor to sink current from the respective electrochemical cell.

10. The multiplexer of claim 8, wherein the second and third transistors are connected in parallel.

11. Apparatus for diagnostic testing of an electrochemical cell stack, comprising the multiplexer of claim 1, and comprising:
a power supply module for supplying power to the power supply circuit of the multiplexer; and
a control module for controlling the power supply module to vary power supplied to the power supply circuit and for controlling the microcontroller of the multiplexer to transmit the power control signals and the switching control signals.

12. The apparatus of claim 11, further comprising a voltage monitor controlled by the control module and electrically connectable to electrodes of the electrochemical cells of the electrochemical cell stack, the voltage monitor being configured to measure the voltages between the electrodes of a selected electrochemical cell.

13. The apparatus of claim 12, wherein the voltage monitor is configured to measure the voltages between the electrodes of successively selected electrochemical cells and to communicate corresponding respective voltage values to the control module during the diagnostic testing.

14. A method for supplying current to one or more electrochemical cells in an electrochemical cell stack during automated diagnostic testing of the stack, the method comprising:
providing a multiplexer for switching current to one or more cells, the multiplexer comprising a microcontroller, a power supply circuit and a plurality of switching circuits;
transmitting a power control signal from the microcontroller to the power supply circuit to cause the power supply circuit to supply power to the plurality of switching circuits;
transmitting switching control signals from the microcontroller to selected ones of the switching circuits to cause the selected ones of the switching circuits to supply current to respective electrochemical cells.

15. The method of claim 14, wherein the power supply circuit comprises a discharge resistance and the method further comprises transmitting discharge control signals from the microcontroller to the power supply circuit to cause the power supply circuit to stop supplying power to the plurality of switches and to allow residual voltage in the selected ones of the switching circuits to be discharged through the discharge resistance.

16. The method of claim 14, wherein each switching circuit has first and second terminals and the switching control signals are received at each switching circuit on the first terminal or on he second terminal of the switching circuit.

17. The method of claim 16, wherein when one of the switching control signals is received on the first terminal of one of the switching circuits, that switching circuit is caused to act as a current supply to the respective electrochemical cell.

18. The method of claim 16, wherein when one of the switching control signals is received on the second terminal of the switching circuits, that switching circuit is caused to act as a current sink to the respective electrochemical cell.

19. A multiplexing system for supplying current to one or more electrochemical cells in an electrochemical cell stack, the system comprising:
a multiplexer, the multiplexer comprising:
a microcontroller,
a plurality of switching circuits, each switching circuit switching circuit switchably supplying current responsive to switching control signals from the microcontroller, to a respective electrochemical cell during the diagnostic testing, and
a power supply circuit responsive to power control signals from the microcontroller for supplying power to the plurality of switching circuits;
a power supply module for supplying power to the power supply circuit of the multiplexer; and
a control module programmed to control the power supply module to vary power supplied to the power supply circuit and to control the microcontroller to transmit the power control signals and the switching control signals.

20. The system of claim 19, wherein the microcontroller is configured to output a first switching signal or a second switching signal to each switching circuit, whereby, when the microcontroller outputs the first switching signal to one of the switching circuits, that switching circuit is enabled to supply current to the respective electrochemical cell and, when the microcontroller outputs the second switching signal to one of the switching circuits, that switching circuit is enabled to sink current from the respective electrochemical cell.

21. The system of claim 20 wherein, depending on the input voltage of the switching circuit, the first switching signal enables first and second transistors or a third transistor and wherein, when the input voltage is large, the first and second transistors operate to pass current to the respective electrochemical cell via the second transistor and, when the input voltage is small, the third transistor operates to pass current to the respective electrochemical cell.

22. The system of claim 20, wherein the second switching signal enables a fourth transistor to sink current from the respective electrochemical cell.

23. The system of claim 19, wherein each switching circuit is configured to receive a varying input voltage from the power supply circuit and to output a correspondingly varying output current to a respective electrochemical cell.

24. The system of claim 19, wherein the switching circuits each comprise transistors having a high current tolerance.

25. The system of claim 24, wherein the transistors are MOSFETs.

26. The system of claim 19, wherein the power supply circuit comprises a first power switch for supplying power to the switching circuits when the first power switch is closed, the first power switch being operable to open or close in response to a first power control signal from the microcontroller.

27. The system of claim 26, wherein the power supply circuit comprises a second power switch for discharging voltage from the electrochemical cells when the first power switch is open and the second power switch is closed, the second power switch being operable to open or close in response to a second power control signal from the microcontroller and wherein the power supply circuit further comprises a discharge resistor connected in series with the second power switch for discharging voltage from the electrochemical cells.

28. The system of claim 19, wherein the control module comprises a computer processor having access to a computer program script and wherein, when the computer processor executes the computer program script, the computer processor automatically controls the power supply module and the microcontroller to supply current to the one or more electrochemical cells.
